(19) United States
(12) Patent Application Publication
(10) Pub. No.: US 2013/0135095 A1
(43) Pub. Date: May 30, 2013

(54) Device Locator

(71) Applicant: Silviu Stochita, Ottawa (CA)

(72) Inventor: Silviu Stochita, Ottawa (CA)

(21) Appl. No.: 13/665,105

(22) Filed: Oct. 31, 2012

Related U.S. Application Data
(60) Provisional application No. 61/564,475, filed on Nov. 29, 2011.

(51) Int. Cl. G08B 1/08

(52) U.S. Cl. 340/539.13

(57) ABSTRACT

A device locator system is disclosed for locating misplaced smart devices or other electronic devices. The device locator system comprises a key fob component and a device component. The key fob component comprises a hand held unit and a transceiver that receives and transmits a signal. The device component is in communication with the misplaced smart device and comprises a transceiver that receives and transmits the signal from the key fob component. Once the response signal from the device component is received by the key fob component, the distance between the key fob and the misplaced device is calculated and then displayed on the LCD screen of the key fob component. The key fob component also comprises a software application that enables the key fob component to be able to register and maintain a list of all smart devices owned by the user.

### CROSS-REFERENCE

This application claims priority from Provisional Patent Application Ser. No. 61/564,475 filed Nov. 29, 2011.

### BACKGROUND

Individuals with smart devices such as laptops, tablets, e-book readers, smart phones, etc., understand the panic and frustration that is felt upon realizing their device is missing. It can be extremely easy to misplace small devices such as these, and unless the missing item is a cell-phone that also happens to be turned on with the ringer volume on loud, it may take several hours or days to find the device, if at all. Further, the expense of replacing missing smart devices is a financial loss that most individuals cannot afford. Additionally, important events can be compromised if an individual cannot find a device when he/she needs it. Furthermore, the importance of the information contained within the smart devices lost and the damage produced if that information is lost can be immeasurable. Thus, owners of smart devices need an efficient and effective product for quickly locating their missing devices.

There is a need for an improved device locator that saves time and frustration by providing owners of smart devices an easy and convenient device for locating misplaced devices. The present invention utilizes radio waves to communicate with a pre-installed device component within a smart device. This invention works to locate missing devices whether or not the device is turned on, ensuring accurate location every time. Thus, users will no longer experience the panic and frustration of misplacing their expensive smart devices, and can maintain peace of mind that their valuable smart devices and information are accounted for at all times. Anyone who owns a smart device will benefit from the convenience and insurance this product provides.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a device locator system for locating misplaced smart devices or other electronic devices. The device locator system comprises a key fob component and a device component. The key fob component comprises a hand held unit and a transceiver that receives and transmits a signal. The device component is in communication with the misplaced smart device and comprises a transceiver that receives and transmits the signal from the key fob component. Once the response signal from the device component is received by the key fob component, the distance between the key fob and the misplaced device is calculated and then displayed on the LCD screen of the key fob component. The direction of the device component is also determined and displayed on the LCD screen of the key fob component.

In a preferred embodiment, the key fob component also comprises a software application. The software application enables the key fob component to be able to register and maintain a list of all smart devices owned by the user. Thus, if the user misplaces one of the smart devices, the user can use the key fob component to scroll through the list of registered smart devices and select a smart device to transmit a signal to. Then, once a response signal is received from the smart device, the location of the misplaced smart device can be calculated.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the key fob component in accordance with the disclosed architecture.

FIG. 2 illustrates a perspective view of the key fob component in accordance with the disclosed architecture.

FIG. 3 illustrates a perspective view of the key fob component emitting a sound in accordance with the disclosed architecture.

FIG. 4 illustrates a perspective view of the LCD screen of the key fob component in accordance with the disclosed architecture.

FIG. 5 illustrates a perspective view of the device locator system in use in accordance with the disclosed architecture.

FIG. 6 illustrates a method of locating a smart device in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses an improved device locator system that saves time and frustration by providing owners of smart devices an easy and convenient device for locating misplaced devices. The present invention utilizes radio waves to communicate with a pre-installed device component within a smart device. This invention works to locate missing devices whether or not the device is turned on, ensuring accurate location every time.

The device locator system comprises a key fob component and a device component. The key fob component comprises a hand held unit and a transceiver that receives and transmits a signal. The device component is in communication with the misplaced smart device and comprises a transceiver that receives and transmits the signal from the key fob component. Once the response signal from the device component is received by the key fob component, the distance between the key fob and the misplaced device is calculated and then displayed on the LCD screen of the key fob component.

Thus, users will no longer experience the panic and frustration of misplacing their expensive smart devices, and can maintain peace of mind that their valuable smart devices and information are accounted for at all times. Anyone who owns a smart device will benefit from the convenience and insurance this product provides.

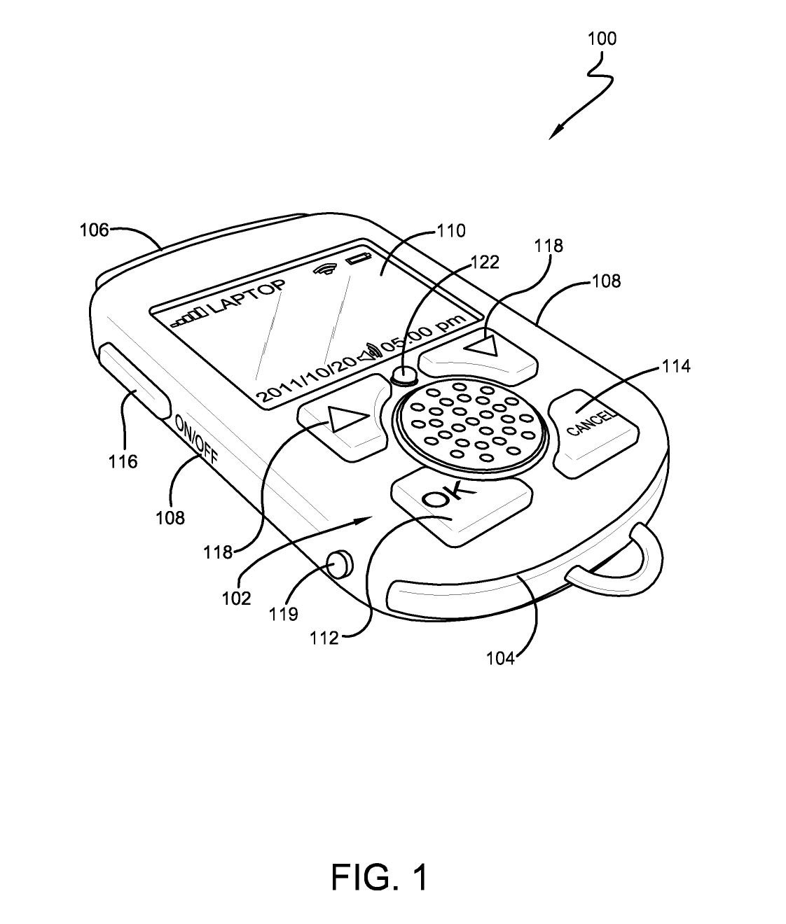

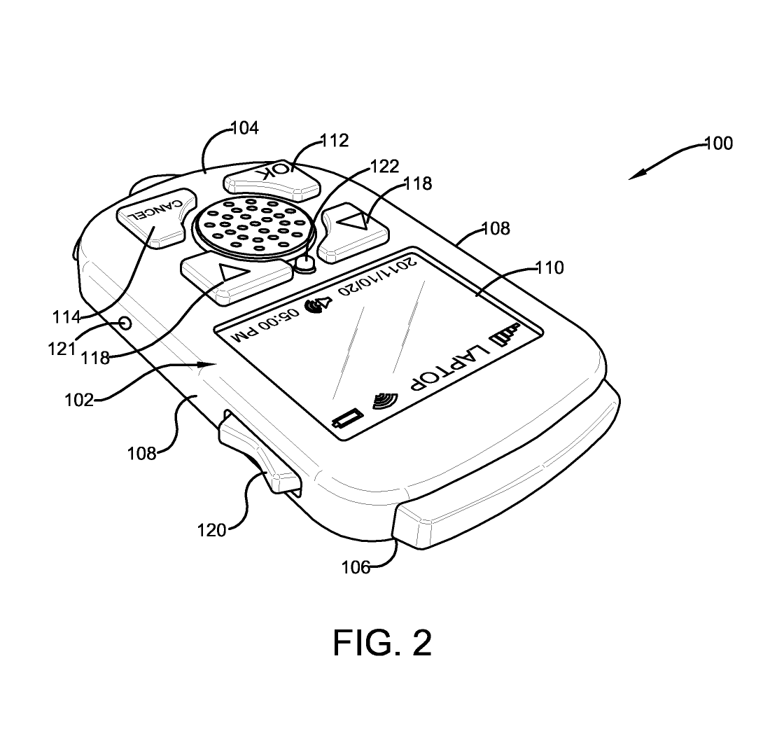

The invention discloses a device locator system for locating misplaced smart devices or other electronic devices. The device locator system comprises a key fob component and a device component. Referring initially to the drawings, FIGS. 1-2 illustrate the key fob component 100 of the device locator system. The key fob component 100 comprises a hand held unit 102 or housing comprising a first end 104 and a second end 106. Typically, the hand held unit 102 is rectangular in shape, however any other suitable shape can be used as is known in the art without affecting the overall concept of the invention.

The hand held unit 102 would generally be constructed of plastic, such as polycarbonate, polyvinyl chloride (PVC), or acrylonitrile butadiene styrene (ABS), though any other suitable material may be used to manufacture the hand held unit 102 as is known in the art without affecting the overall concept of the invention. The hand held unit 102 is approximately between 3.0 and 3.5 inches long as measured from the first end 104 to the second end 106, approximately between 1.5 and 2.0 inches wide as measured from opposing sides 108, and approximately between 1.0 and 1.5 inches thick.

The hand held unit 102 further comprises a liquid crystal display (LCD) screen 110, and various control buttons for controlling functions of the key fob component 100. For example, the key fob component 100 may comprise an “OK” button 112 and a “CANCEL” button 114 that confirm or abandon the options/features displayed on the LCD screen. A user can choose amongst the options displayed on the LCD screen. The key fob component 100 may also comprise an “ON/OFF” button 116 for powering on and off the LCD screen 110 and/or for powering on and off the entire key fob component 100. The key fob component 100 may further comprise volume controls 120 for controlling the volume of the key fob component 100 and for controlling the volume of the emitted sound from the smart device, when the smart device is located.

The key fob component 100 may comprise a voice activation button 121 that turns on and off the voice capabilities of the key fob component 100. Specifically, the key fob component 100 comprises voice capabilities such that when the smart device is located, the coordinates can be “spoken” to a user, or the key fob can emit a sound and/or vibrate. The voice activation button 121 can turn on and off these voice capabilities to prolong battery life of the key fob component 100. Additionally, the key fob component 100 can be programmed to power on and off the smart device(s) registered on the key fob component 100.

The key fob component 100 may further comprise a light emitting diode (LED) 122 that emits luminous signals during the process of locating the smart device. Specifically, the LED 122 may emit a red signal if the smart device cannot be found and a green signal if the smart device is found. Further, button 119 is an LED activation button 119 which turns on and off the LED 122 to further prolong battery life of the key fob component 100. Additionally, the key fob component 100 may further comprise buttons 118 that allow a user to scroll (or navigate) through the various device software features displayed on the LCD screen 110. However, the key fob component 100 is not limited to these functions and can comprise additional functionalities that could be implemented during manufacturing to suit manufacturing needs and consumer preferences, as well as the wants and needs of a user. Furthermore, some of the key fob component's 100 disclosed capabilities can be turned off and on by the user to prolong battery life.

The LCD screen 110 displays the position and direction of the misplaced smart device, but may also display other functionalities of the key fob component 100, such as battery life estimation, the list of registered smart devices on the key fob component 100, the calculated distance between the key fob component 100 and the smart device, etc. The LCD screen 110 may also display the position of the misplaced smart device using geographic coordinates and/or cardinal directions. Furthermore, the “ON/OFF” button 116 allows for the LCD screen 110 to be turned down or off. Additionally, the hand held unit 102 may comprise a memory component (not shown) for storing multiple smart device information and a processor component (not shown) as is known in the art.

The hand held unit 102 of the key fob component 100 comprises a transceiver (not shown), as is known in the art, for receiving and/or transmitting a signal to the smart device. The transceiver is a device that comprises both a transmitter and a receiver and which shares common circuitry. However, the hand held unit 102 does not need to comprise a transceiver and can function with a separate transmitter and a separate receiver instead of the transceiver. If a separate transmitter and receiver are utilized, the transmitter and receiver are in communication with each other and act to transmit and receive signals from the smart device. The signals transmitted and received by the transceiver, transmitter, and/or receiver comprise radio waves, Wi-Fi technology, Bluetooth® wireless technology, etc., as is known in the art. Each smart device registered on the key fob component 100 would be set to a different frequency, thus the transceiver of the key fob component 100 would transmit the unique frequency of the corresponding smart device to receive response signals from the chosen smart device to determine its location. The range for the signal is the same as the range for a radio wave signal, Wi-Fi, or Bluetooth® technology, as is known in the art. Additionally, the key fob component 100 would have Bluetooth® wireless technology and Wi-Fi capabilities, such that it will be able to connect to the Internet. Thus, the information registered with the smart devices can be accessed via the Internet, as well as the key fob component 100.

Furthermore, the hand held unit 102 of the key fob component 100 comprises a software application (not shown). The software application registers and maintains a list of all smart devices owned by the user. The software application may also comprise a security code or other security device. The security code limits the communication between the key fob component 100 and the smart devices to only smart devices owned by the user. Further, the software application may comprise a personal identification number (PIN) code. The PIN code would be required for activating the key fob component 100. Thus, when a smart device is misplaced, the user may browse through the list of smart devices registered on the key fob component 100 via the software application, and choose the smart the device that needs to be located.

Furthermore, as stated supra, the device locator system comprises a device component (not shown). The device component is in communication with the smart device. The smart device comprises a laptop, a tablet, an e-book reader, a smart phone, etc., or any other suitable smart device as is known in the art without affecting the overall concept of the invention. The device component is in communication with the smart device, and is typically installed or embedded within the smart device. However, the device component does not have to be installed within the smart device and can function independently of the smart device as long as the device component is in direct communication with the smart device.

The device component further comprises a transceiver (not shown) for receiving and/or transmitting a signal to the key fob component 100. The transceiver is a device that comprises both a transmitter and a receiver and which shares common circuitry. Further, the device component may comprise an electronic circuit controller that functions as the transceiver to receive and transmit the signal. However, the device component does not need to comprise a transceiver and can function with a separate transmitter and a separate receiver instead of the transceiver. If a separate transmitter and receiver are utilized, the transmitter and receiver are in communication with each other and act to transmit and receive signals from the key fob component. The signals transmitted and received by the transceiver, transmitter, and/or receiver comprise radio waves, Bluetooth® wireless technology, etc., as is known in the art. Each smart device registered on the key fob component 100 would be set to a different frequency, thus the transceiver of the key fob component 100 would transmit the unique frequency of the corresponding smart device to receive response signals from the chosen smart device to determine its location, as is known in the art.

The device component typically functions using the smart device's battery for power. However, the device component could have an external power source, and could function via the external power source. Further, when the misplaced smart device is located, the device component can be programmed such that the misplaced smart device emits a sound. The sound can be a beep, a ring, a ringtone, or any other suitable sound as is known in the art without affecting the overall concept of the invention. The sound signals the smart device's location for quick retrieval. The volume of the sound is controlled by the user via the volume controls 120 of the key fob component 100. Furthermore, the emitted sound increases or decreases in intensity based on the range of distance between the key fob component 100 and the smart device. Additionally, the key fob component 100 allows a user to register different sounds for different smart devices registered. For example, a laptop can produce a beep and a cell phone can produce a ring, etc. when the key fob component 100 is searching for their locations.

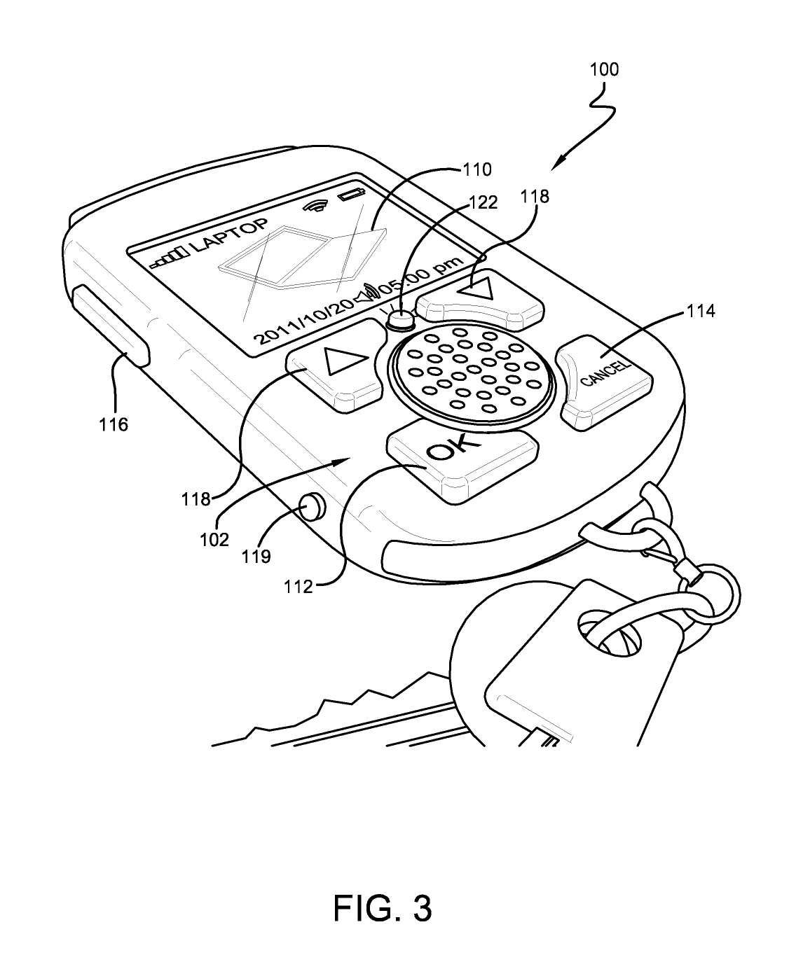

FIG. 3 illustrates the key fob component 100 emitting a sound. As stated supra, the hand held unit 102 comprises an LCD screen 110, and various control buttons for controlling functions of the key fob component 100. For example, the key fob component 100 may comprise an “OK” button 112 and a “CANCEL” button 114 that confirm or abandon the options/features displayed on the LCD screen. The key fob component 100 may also comprise an “ON/OFF” button 116 for powering on and off the LCD screen 110 and/or for powering on and off the entire key fob component 100. The key fob component 100 may further comprise volume controls (as shown in FIG. 2) for controlling the volume of the key fob component 100 and for controlling the volume of the emitted sound from the smart device, when the smart device is located.

The key fob component 100 may further comprise a light emitting diode (LED) 122 that emits luminous signals during the process of locating the smart device. Specifically, the LED 122 may emit a red signal if the smart device cannot be found and a green signal if the smart device is found. Further, button 119 is an LED activation button 119 which turns on and off the LED 122 to further prolong battery life of the key fob component 100. Additionally, the key fob component 100 may further comprise buttons 118 that allow a user to scroll (or navigate) through the various device software features displayed on the LCD screen 110. However, the key fob component 100 is not limited to these functions and can comprise additional functionalities that could be implemented during manufacturing to suit manufacturing needs and consumer preferences, as well as the wants and needs of a user.

Furthermore, when the misplaced smart device is located, the device component can be programmed such that the misplaced smart device emits a sound. The sound can be a beep, a ring, a ringtone, or any other suitable sound as is known in the art without affecting the overall concept of the invention. The sound signals the smart device's location for quick retrieval. The volume of the sound is controlled by the user via the volume controls 120 of the key fob component 100. Furthermore, the emitted sound increases or decreases in intensity based on the range of distance between the key fob component 100 and the smart device. Additionally, the key fob component 100 allows a user to register different sounds for the different smart devices registered.

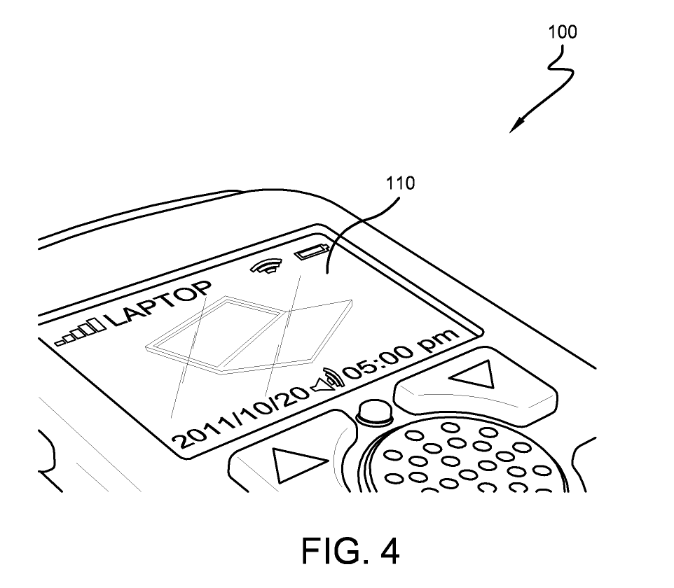

FIG. 4 illustrates the LCD screen 110 of the key fob component 100. Specifically, the key fob component 100 comprises an LCD screen 110, and various control buttons for controlling functions of the key fob component 100. The LCD screen 110 displays the position of the misplaced smart device, but may also display other functionalities of the key fob component 100, such as battery life estimation, the date, the time, the list of registered smart devices on the key fob component 100, the calculated distance between the key fob component 100 and the smart device, etc. The LCD screen 110 may also display the position of the misplaced smart device using geographic coordinates and/or cardinal directions. Furthermore, the “ON/OFF” button 116 allows for the LCD screen 110 to be turned down or off.

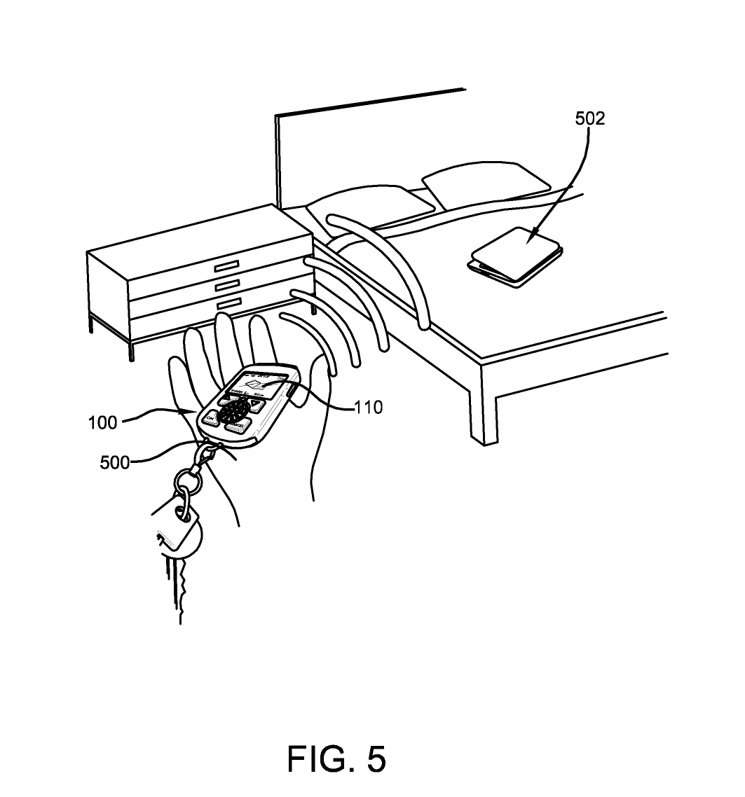

FIG. 5 illustrates the device locator system in use. In operation, a user 500 would install or have the manufacturer install a device component on each smart device 502 he or she owns. The user 500 would then register the smart devices 502 on the key fob component 100, which would use the software application to register and maintain the smart devices 502 and to assign a unique radio wave frequency to each registered smart device 502.

The user 500 would utilize a security code to limit communication between the key fob component 100 and the smart devices 502 to only smart devices owned and registered by the user 500. The user would also utilize a PIN code to activate the key fob component 100. Thus, when a smart device 502 is misplaced, the user 500 activates the key fob component 100 by entering the PIN code.

The user 500 then utilizes the key fob component 100 to scroll through the list of registered smart devices 502 to find the smart device 502 that was misplaced. The user 500 then selects the misplaced smart device 502 and uses the transceiver of the key fob component 100 to transmit the corresponding radio wave signal, as is known in the art, to locate the misplaced smart device 502. Once the misplaced smart device 502 has been located, the device component of the misplaced smart device 502 utilizes its transceiver to receive the transmitted radio wave signal, as is known in the art, from the key fob component 100 and then transmits a response back to the key fob component 100.

Once this response signal is received by the key fob component 100, the distance between the key fob and the misplaced device 502 is calculated and then displayed on the LCD screen 110. The geographic coordinates and/or cardinal directions of the device's location can also be displayed on the LCD screen 110. The device component of the misplaced smart device then programs the smart device to emit a sound to signal its location for quick retrieval. The sound emitted increases or decreases in intensity based on the range of distance between the key fob component 100 and the smart device.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

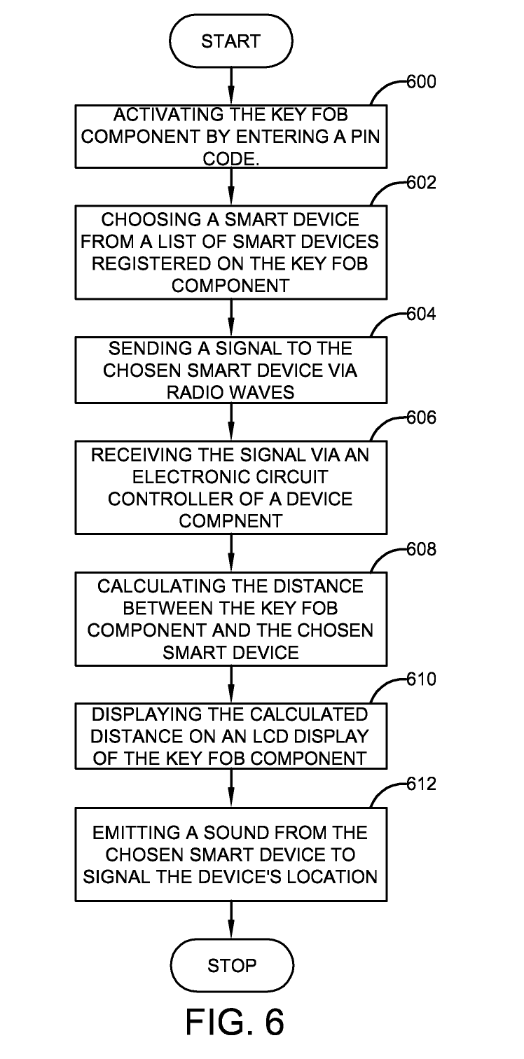

Referring initially to the drawings, FIG. 6 illustrates a method of locating a smart device. The method allows for locating missing smart devices whether or not the device is turned on, ensuring accurate location every time. At 600, the key fob component is activated by entering a PIN code. Thus, when a smart device is misplaced, the user activates the key fob component by entering the PIN code. At 602, a smart device from a list of smart devices registered on the key fob component is chosen. A software application enables the key fob component to register and maintain the smart devices. The user then utilizes the key fob component to scroll through the list of registered smart devices to find the smart device that was misplaced.

At 604, a signal is sent to the chosen smart device via radio waves. Specifically, the transceiver of the key fob component transmits the corresponding radio wave signal to locate the misplaced smart device. The range for the signal is the same as the range for a radio wave signal as is known in the art. At 606, the signal is received via an electronic circuit controller of a device component, wherein the device component is in communication with the chosen smart device. Once the misplaced smart device has been located, the device component of the misplaced smart device utilizes its transceiver to receive the transmitted radio wave signal from the key fob component and then transmits a response back to the key fob component. At 608, the distance between the key fob component and the chosen smart device is calculated. Once the response signal is received by the key fob component, the distance between the key fob and the misplaced device is calculated.

At 610, the calculated distance is displayed on an LCD display of the key fob component. The geographic coordinates and/or cardinal directions of the device's location can also be displayed on the LCD screen. And at 612, a sound is emitted from the chosen smart device to signal the device's location. The sound is emitted to signal the device's location for quick retrieval. The sound emitted increases or decreases in intensity based on the range of distance between the key fob component and the smart device.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device locator system comprising:
a key fob component that comprises a hand held unit and a transceiver that receives and transmits a signal; and
a device component in communication with a smart device, the device component comprises a transceiver that receives and transmits the signal from the key fob component.

2. The system of claim 1, wherein the transceiver of the device component comprises an electronic circuit controller that functions to receive and transmit the signal.

3. The system of claim 2, wherein the signal comprises at least one of radio waves or a blue tooth signal.

4. The system of claim 3, wherein the key fob component comprises a software application that registers and maintains a list of all smart devices.

5. The system of claim 4, wherein the software application comprises a security code.

6. The system of claim 5, wherein the software application comprises a personal identification number (PIN) code for activation.

7. The system of claim 6, wherein the smart device comprises at least one of a laptop, tablet, e-book reader, or smart phone.

8. The system of claim 1, wherein the key fob component comprises a liquid crystal display (LCD).

9. The system of claim 8, wherein the key fob component comprises an “OK” button and a “CANCEL” button.

10. A device locator system comprising:
a key fob component that comprises a hand held unit, a transceiver that receives and transmits a signal, and a software application; and
a device component in communication with a smart device, the device component comprises a transceiver that receives and transmits the signal from the key fob component.

11. The system of claim 10, wherein the signal comprises at least one of radio waves or a blue tooth signal.

12. The system of claim 10, wherein the smart device comprises at least one of a laptop, tablet, e-book reader, or smart phone.

13. The system of claim 10, wherein the key fob component comprises a liquid crystal display (LCD).

14. The system of claim 13, wherein the key fob component comprises an “OK” button and a “CANCEL” button.

15. The system of claim 10, wherein the software application of the key fob component registers and maintains a list of all smart devices.

16. The system of claim 15, wherein the software application comprises a security code.

17. The system of claim 16, wherein the software application comprises a personal identification number (PIN) code for activation.

18. A method of locating a smart device, comprising:
activating the key fob component by entering a PIN code;
choosing a smart device from a list of smart devices registered on the key fob component;
sending a signal to the chosen smart device via radio waves;
receiving the signal via an electronic circuit controller of a device component, wherein the device component is in communication with the chosen smart device; and
calculating distance between the key fob component and the chosen smart device.

19. The method of claim 18, further comprising displaying the calculated distance on an LCD display of the key fob component.

20. The method of claim 19, further comprising emitting a sound from the chosen smart device to signal device's location.
